(19) United States
(12) Patent Application Publication
(10) Pub. No.: US 2007/0228011 A1
(43) Pub. Date: Oct. 4, 2007

(54) Novel chemical composition to reduce defects

(76) Inventors: Mark F. Buehler, Portland, OR (US); Mandyam A. Sriram, Beaverton, OR (US); Danilo Castillo-Mejia, Hillsboro, OR (US); Tatyana N. Andryushchenko, Portland, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/396,012

(22) Filed: Mar. 31, 2006

(51) Int. Cl. B44C 1/22; C09K 13/00; C03C 15/00

(52) U.S. Cl. 216/83; 216/88; 216/89; 216/100; 252/79.1

(57) ABSTRACT

A chemical composition and methods to remove defects while maintaining corrosion protection of conductors on a substrate are described. The composition includes a conductive solution, a corrosion inhibitor; and a surfactant. A surfactant-to-inhibitor ratio in the composition is a function of a metal. The surfactant is an anionic surfactant, a non-ionic surfactant, or any combination thereof. The concentration of the corrosion inhibitor in the chemical composition can be low. The corrosion inhibitor can form soft bonds with a conductor material. The conductive solution can be a high ionic strength solution. The composition is applied to a wafer having conductors on a substrate. At least two conductors on the substrate have different potentials. The composition can be used to clean the wafer after forming the conductors on the substrate. The composition can be used for chemical mechanical polishing of the wafer.

### FIELD

Embodiments of the invention relate to microelectronic device manufacturing. More specifically, embodiments of the invention relate to protection of the microelectronic devices during processing.

### BACKGROUND

Microelectronic integrated circuits are manufactured by forming individual electrical elements e.g., devices, on a silicon substrate and interconnecting the electrical elements. The electrical elements may be transistors, diodes, capacitors, and the like. To form a microelectronic integrated circuit, typically, a dielectric material is deposited over the electrical elements. Metal lines made, for example, of copper (“Cu”) are formed in the dielectric material to connect to various electrical elements on the substrate. Metal lines connected to different electrical elements may have different electrostatic potentials. Typically, a conductive cleaning solution, that includes, for example, citric acid, is used to remove trace metals and other particles from a surface of the wafer after the metal lines are formed. The difference in the electrostatic potential, however, causes a charge transfer between the metal lines when the conductive cleaning solution is applied to the wafer. The charge transfer causes galvanic corrosion of the metal lines. The galvanic corrosion results in partial or complete loss and/or pitting of the metal lines. Currently, to protect copper lines, a high efficiency corrosion inhibitor, such as benzotriazole (“BTA”), is added to the conductive cleaning solution. The BTA being added to the solution has a high concentration of 400 parts per million (“ppm”). Such corrosion inhibitors, however, form very strong bonds with metal lines and leave many residues and defects on the wafer. More specifically, such corrosion inhibitors produce more than tens-of-thousands of residues and defects on the surface of the wafer. Large amounts residues and defects on the wafer lead to an unacceptable process yield.

### BRIEF DESCRIPTION OF THE DRAWINGS

The present invention is illustrated by way of example and not limitation in the figures of the accompanying drawings in which like references indicate similar elements.

FIG. 1A is a side view of one embodiment of a wafer after forming a plurality of conductors.

FIG. 1B is a view similar to FIG. 1A, after a wafer has been cleaned using a chemical composition.

FIG. 1C shows a top view of one embodiment of a wafer after cleaning using a chemical composition.

FIG. 2 illustrates one embodiment of a chemical composition to a clean wafer.

FIG. 3A is a cross-sectional view of one embodiment of a microelectronic structure to fabricate conductors on a substrate.

FIG. 3B is a view similar to FIG. 3A, after depositing an insulating layer on a substrate.

FIG. 3C is a view similar to FIG. 3B, after forming openings in the insulating layer on the substrate.

FIG. 3D is a view similar to FIG. 3C, after depositing a barrier layer on the insulating layer.

FIG. 3E is a view similar to FIG. 3D, after depositing a conductive layer on the barrier layer 306

FIG. 3F is a view similar to FIG. 3E, after the conductive layer is removed from portions of the barrier layer outside the openings in the insulating layer.

FIG. 3G is a view similar to FIG. 3F, after portions of the barrier layer are removed from the insulating layer to form conductors.

FIG. 3H is a view similar to FIG. 3G, after the microelectronic structure is cleaned using a chemical composition.

### DETAILED DESCRIPTION

In the following description, numerous specific details, such as specific materials, dimensions of the elements, chemical names, etc. are set forth in order to provide thorough understanding of one or more of the embodiments of the present invention. It will be apparent, however, to one of ordinary skill in the art that the one or more embodiments of the present invention may be practiced without these specific details. In other instances, microelectronic fabrication processes, techniques, materials, equipment, etc., have not been described in great details to avoid unnecessarily obscuring of this description. Those of ordinary skill in the art, with the included description, will be able to implement appropriate functionality without undue experimentation.

While certain exemplary embodiments of the invention are described and shown in the accompanying drawings, it is to be understood that such embodiments are merely illustrative and not restrictive of the current invention, and that this invention is not restricted to the specific constructions and arrangements shown and described because modifications may occur to those ordinarily skilled in the art.

Reference throughout the specification to “one embodiment”, “another embodiment”, or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all the features of a single disclosed embodiment. Thus, the claims following the Detailed Description are hereby expressly incorporated into this Detailed Description, with each claim standing on its own as a separate embodiment of this invention. While the invention has been described in terms of several embodiments, those skilled in the art will recognize that the invention is not limited to the embodiments described, but can be practiced with modification and alteration within the spirit and scope of the appended claims. The description is thus to be regarded as illustrative rather than limiting.

A chemical composition and methods to remove defects while maintaining a corrosion protection of a plurality of conductors on a substrate are described. The chemical composition includes a conductive solution, a corrosion inhibitor; and a surfactant. A surfactant- to-inhibitor ratio in the chemical composition may be optimized as a function of a metal. The surfactant may be an anionic surfactant, a non-ionic surfactant, or any combination thereof. In one embodiment, the concentration of the corrosion inhibitor in the chemical composition may be substantially low. In another embodiment, a corrosion inhibitor that forms soft bonds with a conductor material (“less effective corrosion inhibitor”) is used in the composition. Less effective corrosion inhibitors have substantially higher water solubility than high effective corrosion inhibitors. In one embodiment, the conductive solution is a high ionic strength solution. The chemical composition is applied to a wafer having a plurality of conductors, e.g., metal lines, on a microelectronic substrate that includes silicon. At least two conductors on the substrate have different potentials. The conductors may include back-end technology connectors, e.g., backside trench connectors, and/or connectors for a front end technology, e.g., metal gate connectors connected to an n-type and/or p-type polysilicon gates of transistors. In one embodiment, the chemical composition is applied to clean the wafer after forming the conductors on the substrate. In another embodiment, the composition may be applied for chemical mechanical polishing of the wafer to form the conductors on the substrate.

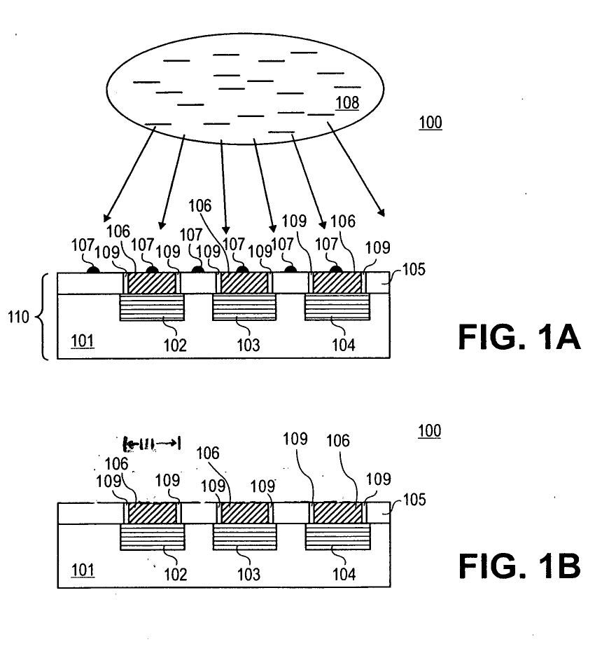

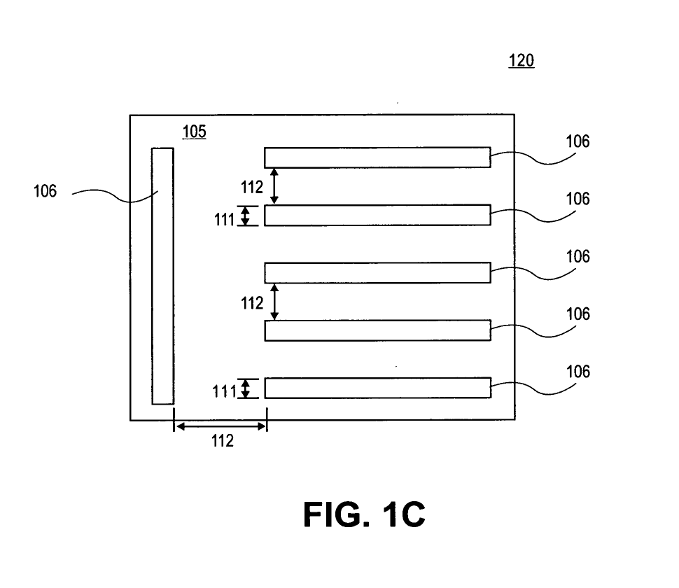

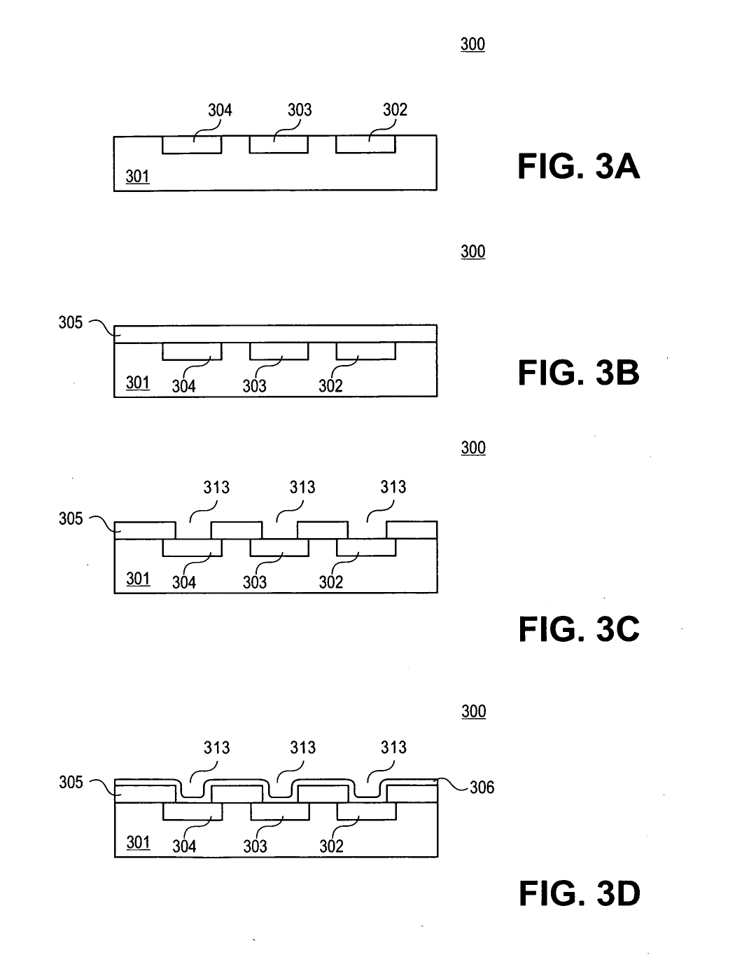

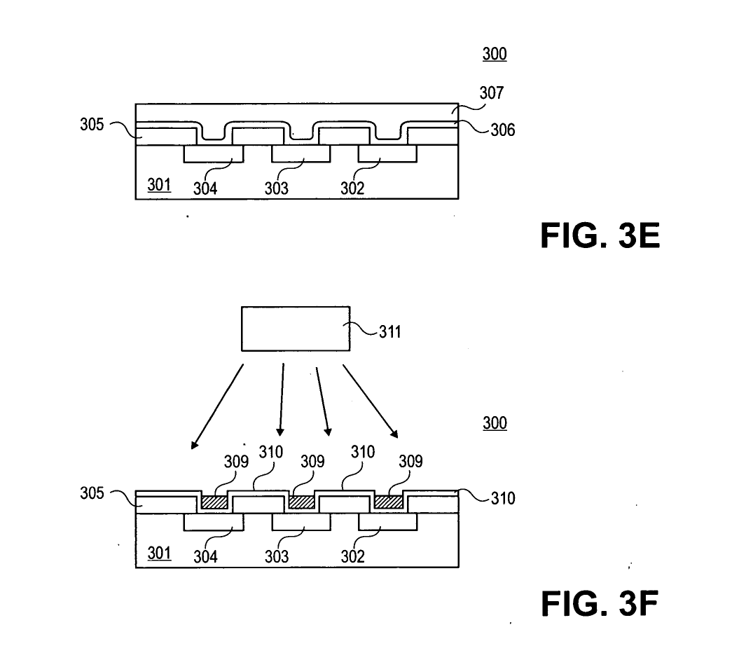

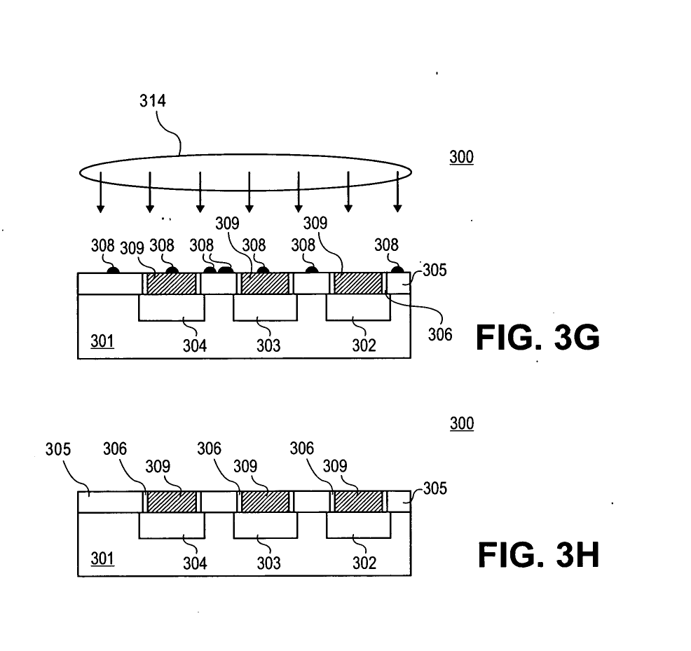

FIG. 1A is a side view of one embodiment of a wafer 110 after forming a plurality of conductors 106. As shown in FIG. 1A, conductors 106 are formed in openings in insulating layer 105 that is deposited on substrate 101. Conductors 106 may be backside connectors (e.g., trench connectors), and/or connectors to metal gates. One embodiment of forming conductors 106 in insulating layer 105 is described in further detail below with respect to FIGS. 3A-3G. Substrate 101 has electrical elements 102-104, as shown in FIG. 1A. Electrical elements 102-104 may be transistors, diodes, capacitors, resistors, or any other active and passive devices to form one or more integrated circuits. In one embodiment, conductors 106 include metal lines formed on a surface of insulating layer 105 that are connected to electrical elements 102-104 through electrical interconnects, as shown in FIG. 1A. In one embodiment, conductors 106 are metal lines that include a reactive metal, e.g., copper. In one embodiment, conductors 106 are metal lines (e.g., copper lines) that are connected to respective n-type and p-type polysilicon gates of electrical elements 102-104 (e.g., transistors) through electrical interconnects. In one embodiment, one of conductors 106 has one electrostatic potential V1 and another of conductors 106 has another electrostatic potential V2. In one embodiment, the difference between one electrostatic potential V1 and another electrostatic potential V2 is in the approximate range of 0. 01 volts (V) to 3 V. More specifically, the difference between the electrostatic potentials V1 and V2 is in the approximate range of 0.1 V to 1.5V. As shown in FIG. 1 A, each of conductors 106 includes a conductive layer, e.g., a copper layer, deposited on a conductive barrier layer 109. In one embodiment, conductive barrier layer 109 is aluminum, titanium, tantalum, tantalum nitride, and the like metals. In one embodiment, conductive barrier layer 109 acts as a diffusion barrier layer to prevent diffusion of a conductive material of the conductive layer, e.g., copper, into insulating layer 105 and substrate 101. In one embodiment, the thickness of conductive barrier layer 106 is in the approximate range of 10 Å to 300 nm. In one embodiment, insulating layer 105 is an interlayer dielectric layer, e.g., oxide, nitride, polymer, or any combination thereof, formed on microelectronic substrate 101. In one embodiment, insulating layer 105 of silicon dioxide is formed on substrate 101 that includes monocrystalline silicon. In one embodiment, the thickness of insulating layer 105 of silicon dioxide deposited on substrate 101 that includes monocrystalline silicon is in the approximate range of 50 nanometers (“nm”) to 1 micron. Forming of insulating layer 105 on substrate 101 that includes, e.g. monocrystalline silicon, is known to one of ordinary skill in the art of microelectronic manufacturing. In alternate embodiments, insulating layer 105 may be any one, or a combination of, sapphire, silicon dioxide, silicon nitride, or other insulating materials. In alternate embodiments, substrate 101 may include III-V and other semiconductors, for example, indium phosphate, gallium arsenide, gallium nitride, and silicon carbide. As shown in FIG. 1A, a chemical composition 108 is applied to wafer 110 after forming conductors 106 that have different electrostatic potentials, to clean the surface of wafer 110 from defects 107 while protecting conductors 106 from the galvanic corrosion. In one embodiment, defects 107 are trace metals, and/or other particles, for example, slurry particles, particles from moving parts within the tool, residue from cleaning chemicals that are left on the surface of wafer 110 after forming conductors 106.

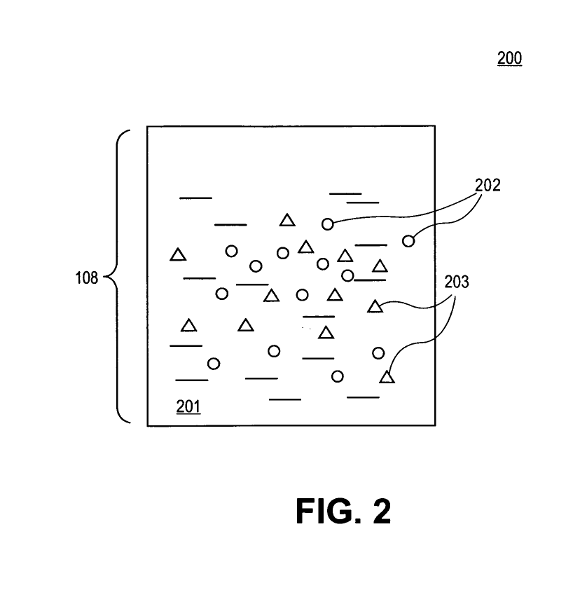

FIG. 2 illustrates one embodiment of chemical composition 108 to clean wafer 110. As shown in FIG. 2, chemical composition 108 includes a conductive solution 201, a corrosion inhibitor 202, and a surfactant 203. Chemical composition 108 may be a buffered cleaning solution, or a non-buffered cleaning solution for robust particle removal and trace metal removal. As shown in FIG. 2, corrosion inhibitor 202 and surfactant 203 are added to conductive solution 201 to simultaneously reduce defects 107 and protect conductors 106 from galvanic corrosion 106. A combination of surfactant 203, corrosion inhibitor 202, and conductive solution 201 eliminates galvanic corrosion of conductors 106 while removing defects 107 from the surface of wafer 110. Adding surfactant 203 to conductive solution 201 allows to reduce the amount of corrosion inhibitor 202 needed to protect conductors 106 from corrosion. In the same time, adding surfactant 203 to conductive solution 201 increases the efficiency of removing of defects 107 from the surface of wafer 110.

Generally, conductive solution 201 includes ions. Free ions in the conductive solution 201 can conduct electricity. In one embodiment, conductive solution 201 includes an organic acid, for example, one or a combination of carboxylic acids, such as acetic acid, citric acid, gluconic acid, glucoronic acid, oxalic acid, and tartaric acid. It is to be appreciated that the list of suitable organic acids is not exhaustive and that other organic acids may be used particularly those having such as multivalent carboxylic acids similar to those listed. The concentration of the acid in conductive solution 201 determines the conductivity of the solution and depends upon the acid selected. In one embodiment, conductive solution 201 includes citric acid at a concentration of about 50 millimole (“mM”). In another embodiment, conductive solution 201 includes an inorganic acid, such as sulfuric acid, nitric acid, and phosphoric acid. These inorganic acids are substantially diluted to reduce their corrosivity to prevent the surface of the metal from becoming too rough. A sulfuric acid having a concentration on the order of less than five percent acid is an example of such a dilution. In one embodiment, conductive solution 201 is a buffered cleaning solution. Generally, the buffered solution refers to the solution that has a pH value (a measure of the activity of hydrogen ions (H⁺) in the solution), maintained at a certain level. In one embodiment of the invention, conductive solution 201 comprising the acid is buffered and comprises an organic acid and a chelating agent. Examples of chelating agents include aliphatic amines, hydroxy alkyl amines, aminocarboxylic acids, cyanides, organosulphides, ammonia ethylyenediaminetetraacetic acid (EDTA), ethlyenediamine (EN), nitrilotriacetic acid (NTA), glycin, diethlyene triamine, and triethanol amine. It is generally believed that chelating agents form bonds with atoms of the metal. It will be appreciated that other chelating agents may be used provided that the chelating agent is capable of forming a bond with a metal that is used in the conductor. In the case of a copper conductor, a chelating agent may be added to bind free (dissolved) copper ions in conductive solution 201 to prevent the copper ions from adsorbing on the surface of the wafer. Conductive solution 201 may be described as a high-ionic strength solution when it can provide a substantially high concentration of ions. In one embodiment, conductive solution 201 comprises 50 millimolar (“mM”) citric acid and 20 mM potassium citrate (or ammonium citrate as an alternative to potassium citrate), and 100 ppm of EDTA. The conductive solution 201 may be diluted with deionized water. In one embodiment, conductive solution 201 having a concentration of an acid in the water of at least 0.01 mM is used. In one embodiment, a pH value of conductive solution 201 is in the approximate range of 3 to 5. In one embodiment, conductive solution 201 is a high-ionic strength solution to clean reactive metals and/or materials (e.g., alloys, and/or compounds, e.g., nitrides) that include reactive metals, e.g., copper (Cu), nickel (Ni), cobalt (Co), chromium (Cr), iron (Fe), manganese (Mn), titanium (Ti), ruthenium (Ru), aluminum (Al), hafnium (Hf), tantalum (Ta), tungsten (W), vanadium (V), molybdenum (Mo), palladium (Pd), gold (Au), platinum (Pt), or any combination thereof.

Generally, a corrosion inhibitor (“CI”) can prevent the corrosion by bonding to the surface of a metal, e.g., copper, and whereby protecting the surface of the metal from the corrosion. Typically, a corrosion inhibitor protects the surface of the metal from the corrosion by providing a thin passivation film on the surface of the metal that stops access of a corrosive substance to the metal. Different types of corrosion inhibitors (“CIs”) may form bonds that vary in strength, e.g., from strong bonds to weak (“soft”) bonds. These different types of corrosion inhibitors are described in further detail below. Typically, the CIs that form strong bonds, protect the surface of the metal from corrrosion, but also cause formation of particles on the surface of the metal. Lowering the concentration of CI in the conductive solution to reduce amount of particles would compromise the inhibition efficiency leading to a poor corrosion protection. Therefore, the concentration of CI needs to be reduced without sacrificing the inhibition efficiency. On the other hand, the corrosion inhibitors that form weak (soft) bonds may not lead to generation of particles on the surface, however they are too weak in protecting the copper surface. In one embodiment, adding surfactant 202 to conductive solution 201 enables the use of strong corrosion inhibitors at substantially low concentration, as described in further detail below. In another embodiment, adding surfactant 202 to conductive solution 201 enables the use of less effective corrosion inhibitors that form soft bonds, to protect the surface of the metal, as described in further detail below.

In one embodiment, surfactant 203 including an anionic surfactant, non-ionic surfactant, or any combination thereof, is added to conductive solution 201, e.g., a conductive solution that includes an active ingredient, e.g., citric acid, and a buffer, e.g., potassium citrate. In one embodiment, surfactant 203 is one or a combination of carboxylates, e.g., ethoxy carboxylates, ether carboxylates, and alkyl (e.g. lauryl) polyglycol ether carboxylic acids. For example, surfactant 203 may be glycolic acid ethoxylate lauryl ether. In another embodiment, surfactant 203 is one or a combination of sulphates, e.g., alcohol ether sulphates, sulphated alkanolamide ethoxylates, and the like. For example, surfactant 203 may be sodium or ammonium dodecyl sulfate. In yet another embodiment, surfactant 203 may be one or a combination of sulphonates, e.g., alcohol ether (or ethoxy) sulphonates, ethane sulphonates, sulphonated acids, and the like. For example, surfactant 203 may be sulphonated oleate potassium salt. In yet another embodiment, surfactant may be one or a combination of phosphates, e.g, phosphate esters, phosphated alcohols, and the like. For example, surfactant 203 may be lauryl polyethyleneglycol phosphate. In one embodiment surfactant 203 may be one or a combination of alcohol ethoxylates, alkanoamides, amine oxides, ethoxylated amines (laurylamine ethoxylate), ethylene oxide/propylene oxide co-polymers, fatty acid ethoxylates, alkyl amines, alkyl imidazolines, alkylphenol ethoxylates, and the like. In one embodiment, corrosion inhibitor 202 forming soft bonds with a metal, e.g. copper (“less effective corrosion inhibitor”) is added to conductive solution 201. For example, less effective corrosion inhibitor 202, such as methyltetrazole (METZ), methylthiotetrazole (MTTZ), triazole (TZ), oxazoles, and thiazoles and their derivatives, may be added to conductive solution 201, e.g., a conductive solution that includes an active ingredient, e.g., citric acid, and a buffer, e.g., potassium citrate. In one embodiment, corrosion inhibitor 202 has high solubility in water, for example, not less than 100 milligrams per liter (mg/L) of water at a room temperature. More specifically, the solubility in water of corrosion inhibitor 202 is in the approximate range of 100 mg/L to 300 mg/L at 20° C. Corrosion inhibitor 202 having the high water solubility increases the efficiency of removal of defects 107 from the surface of wafer 110. In another embodiment, corrosion inhibitor 202 forming strong bonds with a metal, e.g., copper (“more effective corrosion inhibitor”) is added to conductive solution 201. For example, more effective corrosion inhibitor 202 such as one or a combination of benzotriazole (BTA), 1-phenyltetrazole5-thiol, 5-phenyltetrazole having a low concentration not more than 1,000 ppm may be added to conductive solution 201, e.g., a conductive solution that includes an active ingredient, e.g., citric acid, and a buffer, e.g., potassium citrate. More specifically, the concentration of the more effective corrosion inhibitor in the conductive solution may be in the approximate range of 40 ppm to about 100 ppm. In one embodiment, a ratio of surfactant 203 to inhibitor 202 is optimized as a function of a conductive material of conductors 106. In one embodiment, to clean conductors 106 made of copper, surfactant 203 having the concentration in the approximate range of 200 ppm to 10,000 ppm and corrosion inhibitor 202 having the concentration in the approximate range of 10 ppm to 1,000 ppm are added to conductive solution 201. In one embodiment, chemical composition 108 includes conductive solution 201 in the approximate range of 50% and 95% by weight, corrosion inhibitor 202 in the approximate range of 0.001% to 10% by weight, and surfactant 203 in the approximate range of 0.1% to 40% by weight.

FIG. 11 is a view similar to FIG. 1A, after wafer 110 has been cleaned using chemical composition 108. As shown in FIG. 1A, defects 107 are removed and conductors 106 are preserved from the corrosion. In one embodiment, the width 111 of conductors 106 (e.g., copper lines) is in the approximate range of 30 nm to 10 microns (“μm”). In one embodiment, after cleaning wafer 110 with chemical composition 108, the amount of defects 107 is reduced by at least a factor of 5. In one embodiment, the amount of defects 107 after cleaning wafer 110 using chemical composition 108 is reduced from about 100,000 to about 7,000.

FIG. 1C shows a top view 120 of one embodiment of wafer 110, after cleaning using chemical composition 108. As shown in FIG. 1C, a plurality of conductors 106 are deposited onto insulating layer 105 on a substrate. In one embodiment, metal conductors 106, e.g., copper lines include at least one conductor 106 that has one electrostatic potential, and another conductor 106 that has another electrostatic potential. In one embodiment, at least one conductor 106 is electrically connected to one electrical element formed upon a silicon substrate (not shown) and another conductor 106 is connected to another electrical element formed upon the silicon substrate (not shown). In one embodiment, width 111 of conductors 106 (e.g., copper lines) is in the approximate range of 30 nm to 10 microns, and distance 112 between conductors 106 is in the approximate range of 30 nm to 10 microns. Methods of cleaning a wafer having conductors using chemical composition 108 are described in further detail below.

FIG. 3A is a cross-sectional view of one embodiment of a microelectronic structure 300 (e.g., a wafer) to fabricate conductors on a substrate. As shown in FIG. 3A, electrical elements 302-304 are formed upon substrate 301. In one embodiment, electrical elements 302-304 are transistors, diodes, capacitors, resistors, or any other active and passive devices to form one or more integrated circuits upon substrate 301 that includes a monocrystalline silicon. In alternate embodiments, substrate 301 may include III-V and other semiconductors, for example, indium phosphate, gallium arsenide, gallium nitride, and silicon carbide. In yet another embodiment, substrate.301 may include glass, or quartz. Forming electrical elements 302-304, e.g., active and passive devices of an integrated circuit on substrate 301 is known to one of ordinary skill in the art of microelectronic manufacturing.

FIG. 3B is a view similar to FIG. 3A, after depositing an insulating layer 305 on substrate 301 covering electrical elements 302-304. In one embodiment, insulating layer 305 that includes silicon dioxide is deposited onto substrate 301 that includes monocrystalline silicon. Insulating layer 305 may be deposited onto substrate 301 using any blanket deposition techniques known to one of ordinary skill in the art of microelectronic manufacturing e.g., using spin-on, CVD, or sputtering technique. In alternative embodiments, insulating layer 305 may be any one, or a combination of, sapphire, silicon dioxide, silicon nitride, or other insulating materials. In one embodiment, the thickness of insulating layer 305 of silicon dioxide deposited on substrate 301 that includes monocrystalline silicon is in the approximate range of 50 nanometers (“nm”) to 1 micron.

FIG. 3C is a view similar to FIG. 3B, after forming openings 313 in insulating layer 305 on substrate 301 covering electrical elements 302-304. As shown in FIG. 3C, insulating layer 305 is patterned and etched to form openings 313 that expose at least portions of electrical elements 302-304 formed upon substrate 301. Openings 313 are formed to provide electrical interconnects to electrical elements 302-304. In one embodiment, electrical elements 302-304 include transistors, and portions of electrical elements 302-304 exposed in openings 313 are gates of transistors. In one embodiment, a photoresist (not shown) is deposited on the insulating layer 305, patterned, and then etched to form openings 313. Patterning and etching of insulating layer 305, e.g., oxide, nitride, and polymer, deposited on substrate 301 are known to one of ordinary skill in the art of microelectronic manufacturing. In one embodiment, openings 313 in insulating layer 305 on silicon substrate 301 are trenches having the width in the approximate range of 30 nm to 10 μm. In another embodiment, openings 313 are vias having an aspect ratio of a depth to a diameter, for example, in the approximate range of 1.5:1 (e.g., for metal gate connectors) to 100:1 (e.g., for trench connectors).

FIG. 3D is a view similar to FIG. 3C, after depositing a barrier layer 306 on insulating layer 305 covering sidewalls of openings 313 and exposed portions of electrical elements 302-304. In one embodiment, conductive barrier layer 306 includes aluminum, titanium, tantalum, ruthenium, titanium nitride, tantalum nitride, gold, molybdenum, palladium, platinum, or any combination thereof. In one embodiment, conductive barrier layer 306 is a metal alloy or a compound (e.g., a metal nitride) comprising metals, e.g., aluminum, titanium, tantalum, ruthenium, titanium nitride, tantalum nitride, gold, molybdenum, palladium, platinum, or any combination thereof. In one embodiment, conductive barrier layer 306 acts as a diffusion barrier layer to prevent diffusion of a conductive material, e.g., copper, deposited into openings 313 later on in the process, into insulating layer 305 and substrate 301. Conductive barrier layer 306 may be deposited using any thin film deposition technique known to one of ordinary skill in the art of microelectronic manufacturing, e.g., by sputtering, blanket deposition, atomic layer deposition (“ALD”), and the like. In one embodiment, conductive barrier layer 306 has the thickness in the approximate range of 10 Å to 300 nm. In one embodiment, conductive barrier layer 306, e.g., titanium, has the thickness of about 100 nm is deposited onto insulating layer 305 over sidewalls and exposed portions of electrical elements 302-304.

FIG. 3E is a view similar to FIG. 3D, after depositing a conductive layer 307 on conductive barrier layer 306. As shown in FIG. 3E, conductive layer 307 deposited onto conductive barrier layer 306 fills openings 313 and covers portions of barrier layer 306 outside openings 313. In one embodiment, a conductive seed layer (not shown) is first deposited on conductive barrier layer 306 and then conductive layer 307 is formed on conductive seed layer using an electroplating process. In one embodiment, the seed copper layer (not shown) is deposited onto conductive barrier layer 306 that is one or a combination of aluminum, titanium, tantalum, tantalum nitride, and the like metals. Conductive barrier layer 306 acts as a diffusion barrier layer to prevent diffusion of copper into substrate 301, and provides adhesion for the seed copper layer. It would be appreciated to those skilled in the art that depositing of conductive barrier layer 306 may be omitted and conductive layer 307 may be formed on the seed layer deposited directly onto insulating layer 305 and onto exposed portions of electrical elements 302-304. The seed layer may be deposited using any thin film deposition technique known to one of ordinary skill in the art of microelectronic manufacturing, e.g., by sputtering, blanket deposition, atomic layer deposition (“ALD”), and the like. In one embodiment, the seed layer has the thickness in the approximate range of 10 angstroms (Å) to 300 nm. In one embodiment, conductive barrier layer 306, e.g., titanium, has the thickness of about 100 nm, and the copper seed layer has the thickness of about 200 nm. In one embodiment, the choice of a material for the seed layer may vary with a choice of a material of conductive layer 307. For example, if the material for conductive layer 307 includes copper, the material for the seed layer also includes copper. In alternate embodiments, conductive layer 307 includes one or a combination of reactive metals, e.g., copper (Cu), nickel (Ni), cobalt (Co), ruthenium (Ru), aluminum (Al), chromium (Cr), iron (Fe), manganese (Mn), titanium (Ti), hafnium (Hf), tantalum (Ta), tungsten (W), vanadium (V), molybdenum (Mo), palladium (Pd), gold (Au), platinum (Pt). In one embodiment, conductive layer 307 is a metal alloy or a compound (e.g., a metal nitride) comprising metals, e.g., copper (Cu), nickel (Ni), cobalt (Co), ruthenium (Ru), aluminum (Al), chromium (Cr), iron (Fe), manganese (Mn), titanium (Ti), hafnium (Hf), tantalum (Ta), tungsten (W), vanadium (V), molybdenum (Mo), palladium (Pd), gold (Au), platinum (Pt), or any combination thereof. As shown in FIG. 3E, conductive layer 307 covers portions of conductive barrier layer 306 outside openings 313 and in openings 313. In one embodiment, conductive copper layer 307 is deposited onto the seed copper layer by an electroplating process that is known to one of ordinary skill in the art of microelectronic manufacturing. In one embodiment, conductive layer 307 is formed to the thickness in the approximate range of 30 nm to 10 um.

Next, portions of conductive layer 307 are removed from portions of barrier layer 306 outside openings 313 leaving portions of conductive layer 307 in openings 313 intact. The portions of conductive layer 307 outside openings 313 may be removed chemically (e.g., using etching), mechanically (e.g. using polishing), or both, as known to one of ordinary skill in the art of microelectronic manufacturing. In one embodiment, the portions of conductive layer 307 (e.g., copper) outside openings 313 are polished back using a chemical-mechanical polishing (“CMP”) technique, as known to one of ordinary skill in the art of microelectronic manufacturing.

FIG. 3F is a view similar to FIG. 3E, after conductive layer 307 is removed from portions of conductive barrier layer 310 outside openings 313 in insulating layer 305 to form conductors 309. As shown in FIG. 3F, conductors 309 (e.g., metal lines) are deposited in the openings (e.g., trenches) in insulating layer 305 to form a direct electrical contact with each of electrical elements 302-304 (e.g., gates of transistors). Next, portions 310 of conductive barrier layer 306 are removed from insulating layer 305 outside openings 313 using a slurry 311, as shown in FIG. 3F. It would be appreciated to those skilled in the art that as portions 310 are removed from insulating layer 305 and conductors 309 are formed, conductors 309 connected to devices 302-304 may have different electrostatic potentials. For example, at least one of conductors 309 has one electrostatic potential V1 and another of conductors 309 has another electrostatic potential V2. In one embodiment, the difference between one electrostatic potential V1 and another electrostatic potential V2 is in the approximate range of 0.01 volts (V) to 3 V. In one embodiment, the difference between the electrostatic potentials V1 and V2 is in the approximate range of 0.1 V to 1.5V. To remove portions 310 of barrier layer 306 while protecting conductors 309 from a galvanic corrosion, portions 310 are polished away from insulating layer 305 with slurry 311 using a chemical-mechanical polishing (“CMP”) technique. The CMP technique is known to one of ordinary skill in the art of microelectronic manufacturing. In one embodiment, slurry 311 includes a conductive solution, a corrosion inhibitor, and a surfactant to remove defects while maintaining a corrosion protection of conductors 309. The chemical composition including the conductive solution, the corrosion inhibitor, and the surfactant is described above with respect to FIG. 2. In one embodiment, slurry 311 including a conductive solution, e.g., a conductive solution that includes an active ingredient, e.g., citric acid, and a buffer, e.g., potassium citrate, a “more effective” corrosion inhibitor (e.g., benzotriazole) having a concentration in the approximate range of 10 ppm to 100 ppm, and a surfactant (e.g., anionic, non-ionic) having a concentration in the approximate range of 200 ppm to 600 ppm is used to remove portions 310 of conductive barrier layer 306 while protecting conductors 306 from corrosion. In another embodiment, slurry 311 containing a conductive solution (e.g., a conductive solution that includes an active ingredient, e.g., citric acid, and a buffer, e.g., potassium citrate), and a corrosion inhibitor (e.g., benzotriazole, METZ, MTTZ, TZ, oxazoles) having a concentration in the approximate range of 200 ppm to 500 ppm is used to remove portions 310 of conductive barrier layer 306 while protecting conductors 306 from corrosion. In yet another embodiment, slurry containing a conductive solution (e.g., a conductive solution that includes an active ingredient, e.g., citric acid, and a buffer, e.g., potassium citrate), a “less effective” corrosion inhibitor (e.g. METZ, MTTZ, TZ) having a concentration in the approximate range of 10 ppm to 1,000 ppm, and a surfactant (e.g., anionic, or non-ionic) having a concentration in the approximate range of 200 ppm to 10000 ppm is used to remove portions 310 of conductive barrier layer 306 while protecting conductors 306 from corrosion. In another embodiment, when forming of conductive barrier layer 306 is omitted, the portions of conductive layer 307 outside openings 313 are polished away from insulating layer 305 using CMP technique with slurry 311, as described above.

FIG. 3G is a view similar to FIG. 3F, after portions 310 of barrier layer 306 are removed from insulating layer 305to form conductors 309. As shown in FIG. 3G, defects 308 are left on a surface of microelectronic structure 300 after removing portions 310 of barrier layer 306 using CMP. In one embodiment, defects 308 are trace metals, barrier layer residues, and/or other residues left on the surface of the wafer after conductors 309 are being formed. As shown in FIG. 3G, conductors 309 are connected to electrical elements 302-304. At least one of conductors 309 has one electrostatic potential V1 and another of conductors 309 has another electrostatic potential V2. Next, to clean the microelectronic structure 300 and remove defects 308 while protecting conductors 309 from the galvanic corrosion, cleaning solution 314 is applied a surface of the wafer that includes conductors 309 formed in insulating layer 305. Cleaning solution 314 includes a conductive solution, a corrosion inhibitor and a surfactant, as described above with respect to FIG. 2. In one embodiment, cleaning solution 314 includes a conductive solution, a corrosion inhibitor, and a surfactant to remove defects 308 while maintaining a corrosion protection of conductors 309. In one embodiment, cleaning solution 314 including a conductive solution (e.g., a conductive solution that includes an active ingredient, e.g., citric acid, and a buffer, e.g., potassium citrate), a “more effective” corrosion inhibitor e.g., benzotriazole (“BTA”), having a concentration in the approximate range of 10 ppm to 100 ppm, and a surfactant (e.g., anionic, non-ionic) having a concentration in the approximate range of 200 ppm to 600 ppm is used to clean the wafer and remove defects 308 while protecting conductors 309 from corrosion. In yet another embodiment, cleaning solution 314 containing a conductive solution (e.g., a conductive solution that includes an active ingredient, e.g., citric acid, and a buffer, e.g., potassium citrate), a “less effective” corrosion inhibitor (e.g. METZ, MTTZ, TZ) having a concentration in the approximate range of 10 ppm to 1,000 ppm, and a surfactant (e.g., anionic, non-ionic) having a concentration in the approximate range of 200 ppm to 10000 ppm is used to clean the wafer and remove defects 308 while protecting conductors 309 from corrosion.

In one embodiment; the wafer that includes conductors 309 formed on insulating layer 305 is placed in a bath with cleaning solution 314. In one embodiment, the wafer is cleaned in the cleaning solution 314 at a room temperature in the approximate range of 20° C. to 28° C. In another embodiment, the wafer is placed in cleaning solution 314 at a temperature higher than the room temperature depending on the conductive material of conductors 309. In another embodiment, the cleaning solution 314 may be applied to a surface of microelectronic structure 300 containing conductors 309 by a brush. In yet another embodiment, the cleaning solution 314 may be sprayed over the surface of microelectronic structure 300.

FIG. 3H is a view similar to FIG. 3G, after microelectronic structure 300 is cleaned using chemical composition 314. As shown in FIG. 3H, defects 309 are removed from the surface of the insulating layer 305 and from conductors 309. As shown in FIG. 3H, conductors 309 connected to electrical elements 302-304 and having different electrostatic potentials are preserved from the corrosion.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. A composition of matter, comprising:
a conductive solution;
a corrosion inhibitor; and
a surfactant.

2. The composition of matter of claim 1, wherein the conductive solution includes an acid.

3. The composition of matter of claim 1, wherein the surfactant includes a carboxylic acid.

4. The composition of matter of claim 1, wherein the surfactant is an anionic surfactant, a non-ionic surfactant, or any combination thereof.

5. The composition of matter of claim 1, wherein a concentration of the corrosion inhibitor is less than 1,000 pm.

6. The composition of matter of claim 1, wherein the surfactant has a concentration between 200 ppm to 10000 ppm and the corrosion inhibitor has the concentration between 10 ppm to 1,000 ppm.

7. The composition of matter of claim 1, wherein the corrosion inhibitor is selected from a group consisting of methyltetrazole, methylthiotetrazole, triazole, benzotriazole, 1-phenyltetrazole 5-thiol, 5-phenyltetrazole, oxazoles, and any combination thereof.

8. The composition of matter of claim 1, wherein the corrosion inhibitor is benzotriazole having a concentration in a range between 40 ppm to 100 ppm.

9. The composition of matter of claim I, wherein the conductive solution is a high ionic strength solution.

10. The composition of matter of claim 8, wherein the conductive solution is between about 50% and 95% by weight, the corrosion inhibitor is between 0.001% to 10% by weight, and the surfactant is between 0.1% to 40% by weight.

11. A method, comprising:
applying a chemical composition to clean a wafer having a plurality of conductors formed on a substrate, wherein the plurality includes at least a first conductor having a first potential and a second conductor having a second potential, wherein the chemical composition includes a conductive solution, a corrosion inhibitor, and a surfactant.

12. The method of claim 11, wherein the plurality of the conductors is formed by performing operations comprising:
forming trenches in an insulating layer over the substrate;
forming a conductive layer over the insulating layer to fill the trenches;
polishing away portions of the conductive layer outside the trenches to form the plurality of the conductors.

13. The method of claim 12, wherein the applying the chemical composition is performed after the polishing away the portions of the conductive layer.

14. The method of claim 11, wherein the conductors include a reactive metal.

15. A method, comprising:
forming a barrier layer on an insulating layer on a substrate, wherein the insulating layer includes trenches;
forming a conductive layer on the barrier layer to fill the trenches;
polishing away portions of the conductive layer outside the trenches;
polishing away portions of the barrier layer outside the trenches using a slurry that includes a conductive solution, a corrosion inhibitor, and a surfactant, to form a plurality of conductors on the substrate, wherein the plurality includes at least a first conductor having a first potential and a second conductor having a second potential.

16. The method of claim 15, further comprising:
cleaning the plurality of the conductors on the substrate using a solution that includes a conductive solution, a corrosion inhibitor and a surfactant.

17. The method of claim 15, wherein a surfactant-to-inhibitor ratio is a function of a metal of the conductors.

18. The method of claim 15, wherein the conductive solution is a high ionic strength solution.

19. The method of claim 15, wherein a concentration of the corrosion inhibitor is less than 1,000 ppm.

20. The method of claim 15, wherein the conductors include a reactive metal.
